(19) United States
(12) Patent Application Publication
(10) Pub. No.: US 2025/0239155 A1
(43) Pub. Date: Jul. 24, 2025

(54) METHOD AND SYSTEM FOR EFFICIENT PASSAGE OF EMERGENCY VEHICLES THROUGH A ROADWAY

(71) Applicant: GM Global Technology Operations LLC, Detroit, MI (US)

(72) Inventors: Donald K. Grimm, Utica, MI (US); Vivek Vijaya Kumar, Shelby Township, MI (US); Catherine McGee, Almont, MI (US)

(21) Appl. No.: 18/421,019

(22) Filed: Jan. 24, 2024

(51) Int. Cl. G08G 1/0968; G01C 21/34; G08G 1/01

(52) U.S. Cl. CPC G08G 1/0968; G01C 21/3415; G08G 1/0137

(57) ABSTRACT

A method for efficient passage of an emergency vehicle includes detecting the emergency vehicle within a predetermined distance from a host vehicle, determining that a siren of the emergency vehicle is activated and, in response to detecting the emergency vehicle driving within the predetermined distance from the host vehicle and that the siren of the emergency vehicle is activated, determining a current location of the emergency vehicle along a roadway. Further, the method includes determining a direction of movement of the emergency vehicle and providing an alternate route for the host vehicle to reach a vehicle destination that avoids the emergency vehicle based on the current location of the emergency vehicle and the direction of movement of the emergency vehicle.

### INTRODUCTION

The present disclosure relates to systems and methods for managing the traffic flow of emergency vehicles. More particularly, the present disclosure relates to methods and systems for efficient passage of emergency vehicles through a roadway.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Often, emergency vehicles require road user cooperation and compliance to reach their destination in a timely manner. However, many road users have difficulty locating the presence and approach direction of emergency vehicles. For this reason, it is useful to develop a method and system for assisting road users to detect the presence and approach direction of emergency vehicles.

### SUMMARY

The present disclosure describes a method for efficient passage of an emergency vehicle. The method includes detecting the emergency vehicle within a predetermined distance from a host vehicle. The method also includes determining that a siren of the emergency vehicle is activated. The method also includes determining a current location of the emergency vehicle along a roadway in response to detecting the emergency vehicle driving within the predetermined distance from the host vehicle and that the siren of the emergency vehicle is activated. The method also includes determining a direction of movement of the emergency vehicle in response to detecting the emergency vehicle driving within the predetermined distance from the host vehicle and that the siren of the emergency vehicle is activated. The method also includes providing an alternate route for the host vehicle to reach a vehicle destination that avoids the emergency vehicle based on the current location of the emergency vehicle and the direction of movement of the emergency vehicle in response to detecting the emergency vehicle driving within the predetermined distance from the host vehicle and that the siren of the emergency vehicle is activated. The method described in this paragraph improves vehicle technology by allowing the vehicle itself to detect an emergency vehicle and provide an alternate route to avoid the emergency vehicle, thereby allowing the emergency vehicle to each its destination in a timely manner.

The method may include providing an alert to a vehicle operator of the host vehicle that the emergency vehicle is within the predetermined distance from the host vehicle. The method may include muting an entertainment system of the host vehicle in response to detecting the emergency vehicle within the predetermined distance from the host vehicle. The method may include providing information about the emergency vehicle to the vehicle operator. The method may include reporting the information about the emergency vehicle to a remote server. The method may include sending the information about the emergency vehicle to at least one remote server. The method may include receiving, by the remote server, a route of the emergency vehicle, and receiving, by the remote server, an emergency destination of the emergency vehicle. The method may include determining, by the remote server, the alternate route for the host vehicle to reach the vehicle destination that avoids the emergency vehicle based on the route of the emergency vehicle and the emergency destination of the emergency vehicle. The method may include determining whether the emergency vehicle has reached the emergency destination. The method may include reporting to the remote server and the least one remote vehicle that the emergency vehicle has reached the emergency destination. The method further includes coordinating a traffic signal red phase of a traffic light at a planned point along a route of the emergency vehicle to block traffic access to a path of the emergency vehicle. The method further includes commanding a ramp meter to change to a red phase to delay traffic access to a highway. The ramp meter is located at a ramp that leads to the highway.

The present disclosure further describes a system for efficient passage of an emergency vehicle. The system includes a plurality of sensors and a controller in communication with the plurality of sensors. The controller is programmed to execute the method described above.

The present disclosure also describes a tangible, non-transitory, machine-readable medium, comprising machine-readable instructions, that when executed by a processor, cause the processor to execute the method described above.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic diagram of a system for efficient passage of emergency vehicles through a roadway.

FIG. 2 is a flowchart of a method for a host vehicle to avoid an emergency vehicles.

FIG. 3 is a flowchart of a method for an emergency vehicle to provide information about its status and route.

FIG. 4 is a flowchart of a method for a remote server to manage the traffic flow of emergency vehicles.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps.

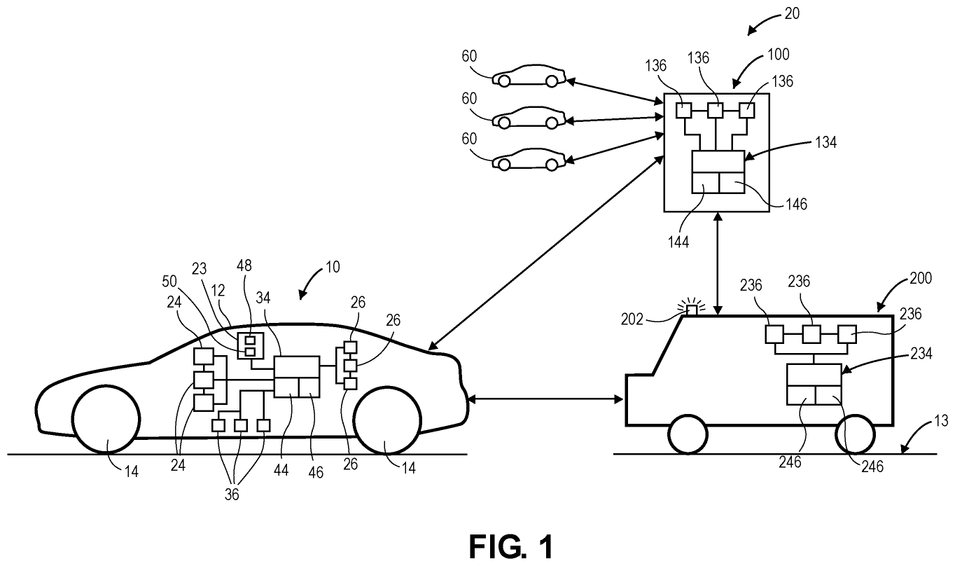

FIG. 1 shows a system 20 for efficient passage of an emergency vehicle 200 through a roadway 13. The system 20 employs vehicle telemetry data to support efficient travel of emergency vehicles 200 through a roadway 13. The system 20 informs a host vehicle 10 whether the emergency vehicle 10 is approaching and the approach direction, thereby maximizing traffic flow in situation where the emergency vehicle travel is required. The system 20 can communicate emergency vehicle presence and approach direction using connected vehicle telemetry. Further, the system 20 determines whether the siren 202 of the emergency vehicle 200 is activated, publishes the route plan of the emergency vehicle 200, and marks map segments where the emergency vehicles 200 are traveling as unavailable or high cost. If a host vehicle 10 is located near the emergency vehicle 200, the system 20 will provide the host vehicle 10 with alternate navigational guidance. If the host vehicle 10 is located on the marked map segments, the system 20 will provide the host vehicle 10 with travel lane advice or alternate route advice to reduce interference with emergency vehicle travel. The system 20 enables automatic lane changes, take over, and/or pull over events based on the connected telemetry data about the emergency vehicle 200.

A host vehicle 10 may be part of the system 20 and generally includes a body 12 and a plurality of wheels 14 coupled to the body 12. The host vehicle 10 may be an autonomous vehicle. In the depicted embodiment, the host vehicle 10 is depicted in the illustrated embodiment as a sedan, but it should be appreciated that other vehicles including trucks, coupes, sport utility vehicles (SUVs), recreational vehicles (RVs), may also be used.

The host vehicle 10 further includes one or more sensors 24 coupled to the body 12. The sensors 24 sense observable conditions of the exterior environment and/or the interior environment of the vehicle 10. As non-limiting examples, the sensors 24 may include one or more cameras, one or more light detection and ranging (LIDAR) sensors, one or more proximity sensors, one or more ultrasonic sensors, one or more thermal imaging sensors, one or more doppler radars, Global Positioning System (GPS) transceivers, and/or other sensors. Each sensor 24 is configured to generate a signal that is indicative of the sensed observable conditions (i.e., sensor data) of the exterior environment and/or the interior environment of the vehicle 10. The signal is indicative of the sensor data collected by the sensors 24.

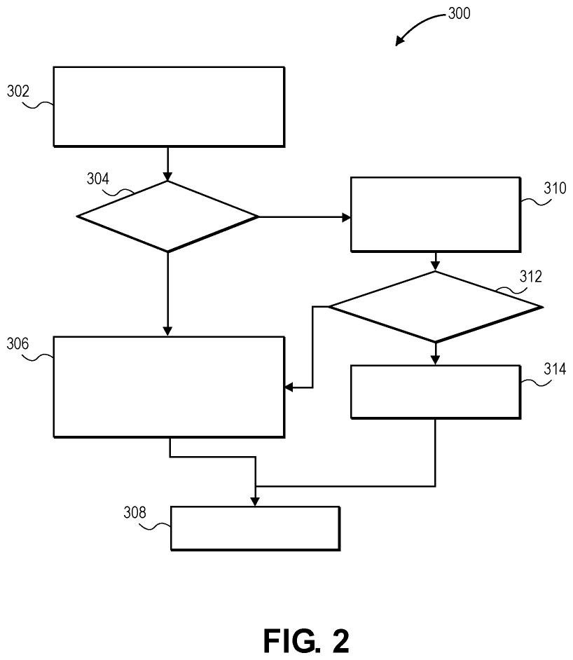

The host vehicle 10 includes a vehicle controller 34 in communication with the sensors 24. The vehicle controller 34 includes at least one vehicle processor 44 and a vehicle non-transitory computer readable storage device or media 46. The vehicle processor 44 may be a custom made or commercially available processor, a central processing unit (CPU), a graphics processing unit (GPU), an auxiliary processor among several processors associated with the vehicle controller 34, a semiconductor-based microprocessor (in the form of a microchip or chip set), a macroprocessor, a combination thereof, or generally a device for executing instructions. The vehicle readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the vehicle processor 44 is powered down. The vehicle computer-readable storage device or media 46 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 34 in controlling the vehicle 10. The vehicle controller 34 is specifically programmed to execute the method 300 (FIG. 2) as described in detail below.

The instructions may include one or more separate programs, each of which comprises an ordered listing of executable instructions for implementing logical functions. The instructions, when executed by the vehicle processor 44, receive and process signals from sensors, perform logic, calculations, methods and/or algorithms for automatically controlling the components of the host vehicle 10, and generate control signals to automatically control the components of the host vehicle 10 based on the logic, calculations, methods, and/or algorithms. Although a single vehicle controller 34 is shown in FIG. 1, embodiments of the host vehicle 10 may include a plurality of vehicle controllers 34 that communicate over a suitable communication medium or a combination of communication mediums and that cooperate to process the sensor signals, perform logic, calculations, methods, and/or algorithms, and generate control signals to automatically control features of the host vehicle 10.

The host vehicle 10 further includes one or more actuators 26 in communication with the vehicle controller 34. The actuators 26 control one or more vehicle features such as, but not limited to, the propulsion system, the transmission system, the steering system, radio, air-conditioning system, one or more haptic actuators, and the brake system of the host vehicle 10. In various embodiments, the vehicle features may further include interior and/or exterior vehicle features such as, but are not limited to, doors, a trunk, and cabin features such as air, music, lighting, entertainment system, etc.

The host vehicle 10 further includes one or more vehicle transceivers 36 in communication with the vehicle controller 34. Each of the vehicle transceivers 36 is configured to wirelessly communicate information to and from other entities using, for example, one or more wireless communication technologies. As non-limiting examples, the wireless communication technologies include near-field communication (NFC), Ultra-wideband (UWB), BLUETOOTH, and Wi-Fi, and a cellular network. As non-limiting examples, the vehicle transceivers 36 may transmit and/or receive information from other vehicles (“V2V” communication), infrastructure (“V2I” communication), remote systems at a remote call center (e.g., ON-STAR by GENERAL MOTORS) and/or personal electronic devices, such as a mobile phone. In certain embodiments, the vehicle transceivers 36 may be configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The host vehicle 10 includes a user interface 23 in communication with the vehicle controller 34. The user interface 23 may be a touchscreen in the dashboard. The user interface 23 may include, but is not limited to, an alarm, such as one or more speakers 48 to provide an audible sound, haptic feedback in a vehicle seat or other object, one or more displays 50, one or more microphones (e.g., a microphone array) and/or other devices suitable to provide a notification to the vehicle user of the vehicle 10. The microphones are configured to capture voice commands by a user of the vehicle 10. The user interface 23 is in electronic communication with the vehicle controller 34 and is configured to receive inputs by a vehicle occupant (e.g., a vehicle operator or a vehicle passenger), such as voice commands. For example, the user interface 23 may include a touch screen and/or buttons configured to receive inputs from a person.

The system 20 includes a remote server 100 in communication with the vehicle 10. As non-limiting examples, the remote server 100 may be a cloud system or an edge system. The remote server includes one or more server transceivers 136 in communication with the vehicle controller 34. Each server transceiver 36 is configured to wirelessly communicate information to and from other entities using, for example, one or more wireless communication networks, such as Wi-Fi networks and/or cellular networks.

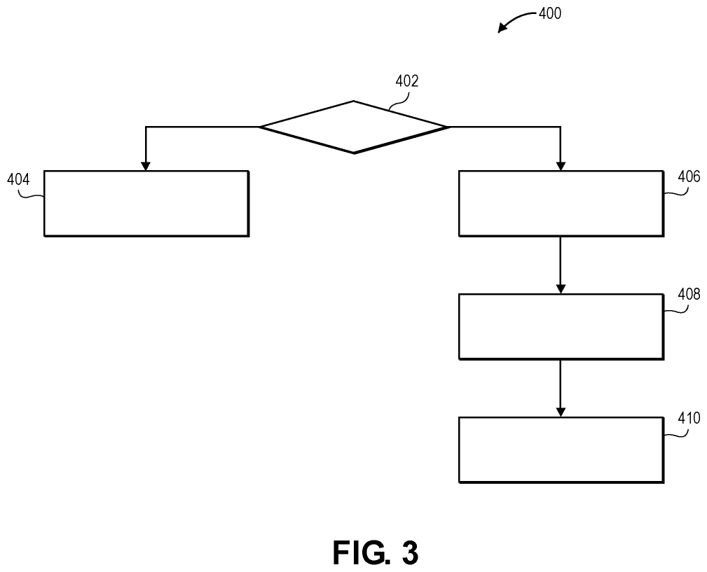

The remote server 100 includes a server controller 134 in communication with the server transceivers 36. The server controller 134 includes at least one server processor 144 and a server non-transitory computer readable storage device or media 146. The server processor 144 may be a custom made or commercially available processor, a central processing unit (CPU), a graphics processing unit (GPU), an auxiliary processor among several processors associated with the server controller 134, a semiconductor-based microprocessor (in the form of a microchip or chip set), a macroprocessor, a combination thereof, or generally a device for executing instructions. The server readable storage device or media 146 may include volatile and nonvolatile storage in read-only memory (ROM), random-access memory (RAM), and keep-alive memory (KAM), for example. KAM is a persistent or non-volatile memory that may be used to store various operating variables while the server processor 144 is powered down. The server computer-readable storage device or media 146 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the server controller 134 in controlling the remote server 100. The server controller 34 is specifically programmed to execute the method 400 (FIG. 3) as described in detail below.

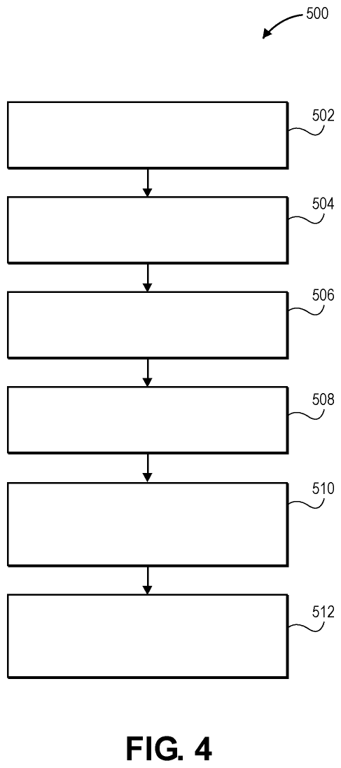

The system 20 further includes one or more emergency vehicles 200 in communication with the host vehicle 10 and the remote server 100. As non-limiting examples, the emergency vehicle 200 may be an ambulance, a law enforcement vehicle, high priority vehicle, vehicle convoy, and/or a fire truck. The emergency vehicle 200 includes an emergency-vehicle controller 234. The emergency-vehicle controller 234 includes at least one emergency-vehicle processor 244 and an emergency-vehicle non-transitory computer readable storage device or media 246. The emergency-vehicle processor 244 may be a custom made or commercially available processor, a central processing unit (CPU), a graphics processing unit (GPU), an auxiliary processor among several processors associated with the emergency-vehicle controller 234, a semiconductor-based microprocessor (in the form of a microchip or chip set), a macroprocessor, a combination thereof, or generally a device for executing instructions. The emergency-vehicle readable storage device or media 246 may include volatile and nonvolatile storage in read-only memory (ROM), random-access memory (RAM), and keep-alive memory (KAM), for example. KAM is a persistent or non-volatile memory that may be used to store various operating variables while the emergency-vehicle processor 244 is powered down. The emergency-vehicle computer-readable storage device or media 246 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the emergency-vehicle controller 234 in controlling the emergency vehicle 200. The emergency-vehicle controller 34 is specifically programmed to execute the method 500 (FIG. 4) as described in detail below.

The emergency vehicle 200 further includes one or more emergency-vehicle transceivers 236 in communication with the emergency-vehicle controller 234. Each of the emergency-vehicle transceivers 236 is configured to wirelessly communicate information to and from other entities using, for example, one or more wireless communication technologies. As non-limiting examples, the wireless communication technologies include near-field communication (NFC), Ultra-wideband (UWB), BLUETOOTH, and Wi-Fi, and a cellular network. As non-limiting examples, the emergency-vehicle transceivers 236 may transmit and/or receive information from other vehicles (“V2V” communication), infrastructure (“V2I” communication), remote systems at a remote call center (e.g., ON-STAR by GENERAL MOTORS) and/or personal electronic devices, such as a mobile phone. In certain embodiments, the emergency-vehicle transceivers 236 may be configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The system 20 further includes one or more remote vehicles 60 in wireless communication with the remote server 100, the host vehicle 10, and/or the emergency vehicle 200. Each of the remote vehicles 60 may include the same components as the host vehicle 10.

FIG. 2 is a flowchart of a method 300 for the host vehicle 10 to avoid an emergency vehicles 200. The method begins at block 302. At block 302, the host vehicle 10 detects that one or more emergency vehicles 200 are within a predetermined distance from the host vehicle 10. To do so, the host vehicle 10 may crowdsource information about the emergency vehicle 200 from one or more remote vehicles 60. Alternatively, or additionally, the host vehicle 10 may use the sensors 24 (e.g., cameras, lidars, radars, etc.) to detect one or more emergency vehicles 200 within the predetermined distance from the host vehicle 10. The host vehicle 10 may also determine that the emergency vehicle 200 is located within the predetermined distance from the host vehicle 10 based on V2V or V2I communications originating from the emergency vehicle 10. These V2V communications stemming from the emergency vehicle 10 contain emergency-vehicle data. Thus, the emergency vehicle 200 may send emergency-vehicle data to the host vehicle 10 and the remote vehicles 60 directly or through the remote server 100. The emergency-vehicle data may include information about the emergency vehicle 200 (e.g., type of emergency vehicle 200, current location of the emergency vehicle 200, status of the siren 202 and/or emergency lights, destination, emergency status, door open or closed, fire hydrant status, other equipment status, and/or whether the first responders are outside the emergency vehicle 200). The vehicle controller 34 receives the emergency-vehicle data directly from the emergency vehicle 200 or through the remote server 100. Based on the emergency-vehicle data, the vehicle controller 34 determines whether the siren 202 of the emergency vehicle 200 is activated. Once the vehicle controller 34 determines that the emergency vehicle 200 is within the predetermined distance from the host vehicle 10 and that the siren 202 of the emergency vehicle 200 is activated, the method 300 proceeds to block 304.

At block 304, the vehicle controller 34 determines whether the current location of the emergency vehicle 200 is available. To do so, the vehicle controller 34 search for the current location of the emergency vehicle 200 in the emergency-vehicle data received from the remote server 100 and/or the emergency vehicle 200. Alternatively, or additionally, the vehicle controller 34 may use the sensors 24 to determine the current location of the emergency vehicle 200. If the location of the emergency vehicle 200 is not available, then the method 300 continues to block 306.

At block 206, the vehicle controller 34 commands the actuators 26 and/or the user interface 23 to perform certain predetermined vehicle operations. For instance, the vehicle controller 34 may command the entertainment system (i.e., one of the actuators 26) to be muted. Alternatively, or additionally, the vehicle controller 34 may command the user interface 23 to provide information about the emergency vehicle 200 to the vehicle operator of the host vehicle 10 using the speakers 48, haptic feedback, and/or one or more displays 50. The information provided to the vehicle operator may include the presence of the emergency vehicle 200 within the predetermined distance from the host vehicle 10. Next, the method 300 proceeds to block 308. At block 308, the vehicle controller 34 reports the information about the emergency vehicle 10 to the remote server 100.

At block 304, if the current location of the emergency vehicle 200 is available, then the method 300 proceeds to block 310. At block 310, the vehicle controller 34 determines and monitors the current location of the emergency vehicle 200 using the emergency-vehicle data received from the remote server and/or directly from the emergency vehicle 200 and or the sensor data received from the sensors 24. In addition, the vehicle controller 34 determines the direction of movement of the emergency vehicle 200 relative to the host vehicle 10. Then, the method 300 continues to block 312.

At block 312, the vehicle controller 34 determines whether the location and/or direction of movement of the emergency vehicle 200 is relevant to the movement and/or location of the host vehicle 10 using, among other things, the emergency-vehicle data. For example, the vehicle controller 34 determines whether the route of the emergency vehicle 200 intersects the route of the host vehicle 10. If the location and/or direction of movement of the emergency vehicle 200 is not relevant to the movement and/or location of the host vehicle 10, then the method 300 proceeds to block 306. If the location and/or direction of movement of the emergency vehicle 200 is relevant to the movement and/or location of the host vehicle 10, then the method 300 continues to block 314.

At block 314, the vehicle controller provides an alert or warning to the vehicle operator through, for example, the user interface 23. The alert may indicate the presence of the emergency vehicle 200. Further, the vehicle controller 34 may receive an alternate route for the host vehicle 10 from the remote server 100. The alternate route can reach the vehicle destination of the host vehicle 10 while avoiding the emergency vehicle 200. The remote server 100 may determine the alternate route based on the current location of the emergency vehicle 200 and the direction of movement of the emergency vehicle 200 relative to the host vehicle 10. For example, map segments along the route of the emergency vehicle 200 may be marked as unavailable or assigned relatively-high traversal costs to discourage access the map segments along the route of the emergency vehicle 200, thereby facilitating increased traffic flow for the emergency vehicle 200 during an emergency. The vehicle controller 34 may also provide navigational guidance to avoid the path of the emergency vehicle 200. For instance, the vehicle controller 34 may provide (through the user interface 23) directional lane advice for moving to a target lane or pulling over to the side of the road. At this juncture, the system 20 may disable the active noise cancellation features. Further, siren directional audio may be played within the host vehicle 10. The system 20 may interface with traffic signal controls to optimize the alternate route by considering the traffic light and status. Regardless of the specific navigational guidance provided to the host vehicle 10, the emergency vehicle 200 is prioritized along the route to reach the emergency destination. It is envisioned that the vehicle controller 34 may command the host vehicle 10 to move autonomously in accordance with the alternate route provided by the remote server 100. Then, the method 300 proceeds to block 308.

FIG. 3 is a flowchart of a method 400 for the emergency vehicle 200 to provide information about its status and route. The method 400 begins at block 402. At block 402, the emergency-vehicle controller 234 determines whether the emergency vehicle 200 has reached its emergency destination. If the emergency vehicle 200 has reached its emergency destination, then the method 400 proceeds to block 404. At block 404, the emergency-vehicle controller 234 communicates the status of the emergency vehicle 200 to the remote server 100, the host vehicle 10, and/or the remote vehicles 60. The status of the emergency vehicle 200 may include the type of emergency vehicle 200, current location of the emergency vehicle 200, status of the siren 202 and/or emergency lights, emergency status, door open or closed, fire hydrant status, other equipment status, and/or whether the first responders are outside the emergency vehicle 200 or other responder status. If the emergency vehicle 200 has not reached its emergency destination, then the method 400 proceeds to block 406. At block 406, the emergency-vehicle controller 234 communicates the status and the immediate route of the emergency vehicle 10 to the remote server 100. The status of the emergency vehicle 200 may include the type of emergency vehicle 200, current location of the emergency vehicle 200, status of the siren 202 and/or emergency lights, emergency status, door open or closed, fire hydrant status, other equipment status, and/or whether the first responders are outside the emergency vehicle 200. Next, the method 400 continues to block 408. At block 408, the emergency-vehicle controller 234 receives the optimal route to the emergency destination. The optimal route may be the quickest route to reach the emergency destination by considering the alternate route of the host vehicle 10, the location and movement of the remote vehicles 60, and the traffic light status and timing. The emergency-vehicle controller 234 may command the emergency vehicle 200 to move according to the optimal route (e.g., quickest route) to reach the emergency destination. Then, the method 400 continues to block 410. At block 410, the emergency-vehicle controller 234 communicates the status of the emergency vehicle 200 to the host vehicle 10 and/or remote vehicles 60.

FIG. 4 is a flowchart of a method 500 for the remote server 100 to manage the traffic flow of emergency vehicles 200. The method 500 begins at block 502. At block 502, the remote server 100 receives the status and the immediate route and destination from the emergency vehicle 200. The status of the emergency vehicle 200 may include the type of emergency vehicle 200, current location of the emergency vehicle 200, status of the siren 202 and/or emergency lights, emergency status, door open or closed, fire hydrant status, other equipment status, and/or whether the first responders are outside the emergency vehicle 200 or other responder status. Then, the method 500 continues to block 504. At block 504, the remote server 100 receives data from emergency response centers when available. Next, the method 500 continues to block 506. At block 506, the remote server 100 aggregates the vehicle trajectory data from all connected vehicles (e.g., the host vehicle 10 and the remote vehicles 60). Then, the method 500 continues to block 508.

At block 508, the remote server 100 analyzes the traffic along the route of the emergency vehicle 200 and determines possible delays for the emergency vehicle 200. Then, the method 500 proceeds to block 510. At block 510, the remote server 100 negotiates traffic light priority and preemptions along the route of the emergency vehicle 200. For example, the remote server 100 can coordinate the traffic signal red phase of one or more traffic lights at planned points along the route of the emergency vehicle 100. In doing so, the remote server 100 can command the traffic lights to change to the red status to block traffic from the other vehicles (e.g., host vehicle 10 and/or remote vehicles 60), thereby allowing the emergency vehicle 200 to drive through those traffic lights without interference by other vehicles. In another example, the remote server 100 can command ramp meters to change to a red phase to delay access to a freeway or highway through a ramp when the emergency vehicle 200 is moving along the freeway or highway. Also, the remote server 100 may command the ramp meter to temporarily disable ramp metering when the emergency vehicle 100 is planning to use the ramp where the ramp meter is located. Further, at block 510, the remote server 100 generates an optimal route (e.g., quickest route) to reach the emergency destination by considering the aggregate vehicle trajectory data from all the connected vehicles, the traffic along the route of the emergency vehicle 200, the delays along the route of the emergency vehicle 200, and the traffic light priority and preemption along the route of the emergency vehicle 200. This optimal route is provided to the emergency vehicle 200. Then, the method 500 continues to block 512. At block 512, the remote server 100 provides information and/or warning about the emergency vehicle 200 (i.e., emergency-vehicle data) to all the connected vehicles (e.g., host vehicle 10 and/or remote vehicles 60) along the route of the emergency vehicle 200. The remote server 100 also generates an alternate route for the host vehicle 10 to avoid the emergency vehicle 100. This alternate route is provided to the host vehicle 10.

The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Embodiments of the present disclosure are described herein. It is to be understood, however, that the disclosed embodiments are merely examples and other embodiments can take various and alternative forms. The figures are not necessarily to scale; some features could be exaggerated or minimized to display details of particular components. Therefore, specific structural and functional details disclosed herein are not to be interpreted as limiting, but merely as a representative basis for teaching one skilled in the art to variously employ the presently disclosed system and method. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for efficient passage of an emergency vehicle, comprising:
detecting the emergency vehicle within a predetermined distance from a host vehicle;
determining that a siren of the emergency vehicle is activated;
in response to detecting the emergency vehicle driving within the predetermined distance from the host vehicle and that the siren of the emergency vehicle is activated, determining a current location of the emergency vehicle along a roadway;
in response to detecting the emergency vehicle driving within the predetermined distance from the host vehicle and that the siren of the emergency vehicle is activated, determining a direction of movement of the emergency vehicle; and
in response to detecting the emergency vehicle driving within the predetermined distance from the host vehicle and that the siren of the emergency vehicle is activated, providing an alternate route for the host vehicle to reach a vehicle destination that avoids the emergency vehicle based on the current location of the emergency vehicle and the direction of movement of the emergency vehicle.

2. The method of claim 1, further comprising providing an alert to a vehicle operator of the host vehicle that the emergency vehicle is within the predetermined distance from the host vehicle.

3. The method of claim 2, further comprising muting an entertainment system of the of the host vehicle in response to detecting the emergency vehicle within the predetermined distance from the host vehicle.

4. The method of claim 3, further comprising providing information about the emergency vehicle to the vehicle operator.

5. The method of claim 4, further comprising reporting the information about the emergency vehicle to a remote server.

6. The method of claim 5, further comprising sending the information about the emergency vehicle to at least one remote server.

7. The method of claim 6, further comprising:
receiving, by the remote server, a route of the emergency vehicle; and
receiving, by the remote server, an emergency destination of the emergency vehicle.

8. The method of claim 7, further comprising determining, by the remote server, the alternate route for the host vehicle to reach the vehicle destination that avoids the emergency vehicle based on the route of the emergency vehicle and the emergency destination of the emergency vehicle.

9. The method of claim 8, further comprising determining whether the emergency vehicle has reached the emergency destination.

10. The method of claim 9, further comprising coordinating a traffic signal red phase of a traffic light at a planned point along a route of the emergency vehicle to block traffic access to a path of the emergency vehicle.

11. A system for efficient passage of an emergency vehicle, comprising:
a plurality of sensors;
a controller in communication with the plurality of sensors, wherein the controller is programmed to:
detect the emergency vehicle within a predetermined distance from a host vehicle;
determining that a siren of the emergency vehicle is activated;
in response to detecting the emergency vehicle driving within the predetermined distance from the host vehicle and that the siren of the emergency vehicle is activated, determine a current location of the emergency vehicle along a roadway;
in response to detecting the emergency vehicle driving within the predetermined distance from the host vehicle and that the siren of the emergency vehicle is activated, determine a direction of movement of the emergency vehicle; and
in response to detecting the emergency vehicle driving within the predetermined distance from the host vehicle and that the siren of the emergency vehicle is activated, provide an alternate route for the host vehicle to reach a vehicle destination that avoids the emergency vehicle based on the current location of the emergency vehicle and the direction of movement of the emergency vehicle.

12. The system of claim 11, wherein the controller is programmed to provide an alert to a vehicle operator of the host vehicle that the emergency vehicle is within the predetermined distance from the host vehicle.

13. The system of claim 12, wherein the controller is programmed to mute an entertainment system of the of the host vehicle in response to detecting the emergency vehicle within the predetermined distance from the host vehicle.

14. The system of claim 13, wherein the controller is programmed to provide the information about the emergency vehicle to the vehicle operator.

15. The system of claim 14, wherein the controller is programmed to report the information about the emergency vehicle to a remote server.

16. The system of claim 15, wherein the controller is programmed to send the information about the emergency vehicle to at least one remote server.

17. The system of claim 16, wherein the controller is programmed to:
receive, by the remote server, a route of the emergency vehicle; and
receive, by the remote server, an emergency destination of the emergency vehicle.

18. The system of claim 17, wherein the controller is programmed to determine the alternate route for the host vehicle to reach the vehicle destination that avoids the emergency vehicle based on the route of the emergency vehicle and the emergency destination of the emergency vehicle.

19. The system of claim 18, wherein the controller is programmed to determine whether the emergency vehicle has reached the emergency destination.

20. The system of claim 19, wherein the controller is programmed to command a ramp meter to change to a red phase to delay traffic access to a highway, wherein the ramp meter is located at a ramp that leads to the highway, or conversely temporarily disabling ramp metering if an emergency vehicle plans to access a metered highway.
